(19) United States
(12) Patent Application Publication
(10) Pub. No.: US 2006/0192308 A1
(43) Pub. Date: Aug. 31, 2006

(54) Manufacturing method for pixilated crystal

(76) Inventor: Jack E. Juni, Royal Oak, MI (US)

Correspondence Address: Douglas L. Wathen;Gifford, Krass, Groh, Sprinkle,, Anderson & Citkowski, P.C., PO Box 7021, Troy, MI, 48007-7021, US

(21) Appl. No.: 11/281,805

(22) Filed: Nov. 17, 2005

Related U.S. Application Data
(60) Provisional application No. 60/629,410, filed on Nov. 19, 2004.

(51) Int. Cl. B29D 11/00

(52) U.S. Cl. 264/1.21

(57) ABSTRACT

Apparatus and methods for shaping a surface of a material are described. An example method comprises providing one or more shaping elements, softening the material, and urging the one or more shaping elements against the material so as to form one or more grooves in the material. The configuration of shaping elements can be adjusted to provide a desired pattern of grooves in the surface. The method can be applied to inorganic crystals in a high temperature plastic state, avoiding the problems associated with conventional sawing techniques.

### REFERENCE TO RELATED APPLICATION

This application claims priority of U.S. Provisional Patent Application Ser. No. 60/629,410, filed Nov. 19, 2004, the entire content of which is incorporated herein by reference.

### FIELD OF THE INVENTION

The invention relates to improved apparatus and methods for shaping a material, for example for forming grooves in a surface of a scintillation crystal.

### BACKGROUND OF THE INVENTION

Edge reflections from an optical element can degrade positional accuracy of optical signals obtained from the optical element. One example is the scintillator crystal, where the position of light emission from a face is used in medical imaging. A scintillation material, or scintillator, produces light in response to incident radiation, typically ionizing radiation such as gamma rays or x-rays. Such a material can be a crystal such as thallium-doped sodium iodide, NaI(Tl), or a non-crystalline material such as a plastic. Scintillators are described in more detail in my co-pending application “Edge effects treatment for crystals”, U.S. patent application Ser. No. 10/993,012, filed Nov. 19, 2004, the entire content of which is incorporated herein by reference.

U.S. Patent Application Publication 2003/0034455 to Schreiner et al. suggests segmenting the scintillator crystal into a number of triangular segments for improved positional accuracy. A typical approach to segmenting or forming grooves in an optical element such as a scintillator crystal is to form the grooves or segments with a saw. However, this can lead to fracture of brittle or weak materials, produces dust, and can add significant time and expense. When cutting glass, there is a high risk of fracture, often requiring the use of diamond saws and sometimes requiring pressure feedback on the shaping element. When cutting plastic, it is difficult to cut the material without burning or discoloration due to heat at the cutting point. Hence, improved methods and apparatus for shaping such materials are needed.

These problems are common where any material surface is to be shaped. Hence, there is a need for improved methods for producing a desired surface topography or otherwise shaping an optical element (such as a scintillation crystal, lens, window, reflector, laser, light emitting device, or fiber), or other material.

### SUMMARY OF THE INVENTION

Improved methods of shaping optical elements, such as scintillators, are described. In one example, grooves are formed in the surface of a scintillator by urging a shaping element, such as a blade or wire, into the surface of the material. The grooves may be formed near an edge to reduced edge reflection effects, at intervals over a light emitting face to improve spatial resolution, or for any other purpose. In other examples, a single scintillator is segmented into a number of segments to improve spatial resolution. The improved methods may be used with plastic scintillator materials, which include polymeric materials, and also inorganic materials that have a plastic state at temperatures below the melting point.

For example, a method of shaping a surface of a material comprises providing a plurality of shaping elements, the shaping elements being mechanically associated so as to move cooperatively, softening the material, and urging the plurality of shaping elements at least partway into the surface of the material, so as to form a plurality of grooves in the material. The shaping elements can include wires, blades, or other form, and may be electrically heated so as to soften the material when proximate to the material. The shaping elements can be disposed across a frame opening defined by a frame. The frame may be rigid and have a frame thickness, the frame thickness providing a depth to the frame opening. The shaping elements can be distributed at different depths within the frame opening so as to produce grooves of different depths. In other examples, a single shaping element can be used to form multiple grooves, for example using a step and repeat process.

Methods of shaping a material surface according to embodiments of the present invention can be used to modify the properties (including spatial distribution) of light emerging from the surface. For example, edge reflections within a scintillator can be reduced by forming grooves close to an edge of the material. Diffractive or other optical properties can also be introduced to the surface.

The material can be softened before the shaping elements enter the material, or the material may be presented in a softened form, such as an uncured or partially cured polymer. The material can be subsequently hardened after surface shaping. The hardening may include cooling, curing, radiation exposure, mechanical processing, and the like. The material may comprise a glass, plastic, crystalline material, semiconductor, dielectric, metal, alloy, or other material. The material may be an optical material, such as an optical plastic. In examples of the present invention, the material is a scintillator.

An apparatus for assisting the formation of grooves in a surface of a material comprises a frame at least partially surrounding a frame opening. In one example, the frame has opposed first and second frame members, a third member rigidly interconnecting the first and second frame members at one end thereof, and optionally a fourth member rigidly interconnecting the other ends of the first and second members. The first and second frame members have a frame thickness, the frame thickness providing a depth to the frame opening. The shaping elements extend across the frame opening between the first and second members, and may be grouped in two groups, proximate to the third and fourth members, respectively. Each shaping element can be located at a predetermined depth within the frame opening, so as to provide grooves of different groove depths.

Embodiments of the present invention can be used to enhance the spatial resolution of a scintillator by forming a plurality of grooves within a surface of the scintillator. The grooves may be disposed so as to form a grid pattern over a surface of the scintillator. The grid pattern may be rectangular, or other geometry. The grooves may extend through the scintillator, so as to segment a single crystal into a number of segments. The shaping element used to form the grooves may remain in the scintillator, and may then provide light guiding, or advantageously modify the distribution of detected radiation in the case of structures including radio-opaque materials.

### BRIEF DESCRIPTION OF THE DRAWINGS

FIG. 1 shows a frame and wire grid combination, which can be used to produce a rectangular pattern of grooves;

FIG. 2 shows a frame and wire array combination, the wire array being located within a peripheral region of the frame opening;

FIG. 3 shows a cross section through a frame and wire array, showing the individual wires being located at different depths relative to the top of the frame;

FIG. 4 illustrates a process of manufacturing an array of grooves in a material, in which a frame is moved towards the material;

FIG. 5 shows the wire array being pressed partway into the material; and

FIG. 6 shows an optical element having an array of grooves formed in one surface, manufactured by a method according to the present invention.

### DETAILED DESCRIPTION OF THE INVENTION

There are many reasons to modify the surface shape of a material. In the case of scintillators, internal edge reflections degrade the positional accuracy of detected scintillation light. This is described in more detail in my co-pending application, “Edge effects treatment for crystals”, U.S. patent application Ser. No. 10/993,012, filed Nov. 19, 2004. In this context, positional accuracy refers to the spatial relationship between the detected scintillation photons and actual scintillation events, and hence to the distribution of ionizing radiation incitement on the scintillator. Edge reflections allow scintillation light to take multiple paths out of the scintillator, namely a direct exit and internally reflected from an edge. Positional accuracy can be improved by a number of approaches, including dividing a single scintillator into multiple material segments, or by forming grooves in the surface of the scintillator. In particular, grooves formed in a peripheral region of the scintillator, close to edges, were found highly effective in increasing positional accuracy of the scintillator. Further, it was found that the groove depths need not be constant within the scintillator, but may have a depth distribution with the deepest grooves close to the edge. Edge reflections cause problems in other optical elements, hence a general approach to shaping the surface of a material forming an optical element would be very valuable.

An example improved method of shaping a surface of a material, such as a scintillator or other optical element, includes forming grooves in a surface. An example includes providing one or more wires, and urging the wires into the surface so as to form a groove. For example, a material such as a scintillator may be heated, or otherwise softened, and one or more wires used to provide one or more grooves in the surface. A plurality of parallel wires can be used to produce a plurality of parallel grooves. This approach can also be used to form grooves in other optical elements, such as a window, lens, waveguide, reflector, fiber, or other optical element.

The same wire array can be used to form grooves in multiple optical elements, such as a scintillator and window, or different wire arrays used.

A groove may remain with appreciable thickness, for example equal to the wire diameter, after the wires are passed through. Alternatively, a material may tend to close up above a wire as the wire passes through the material. However, a reflecting boundary such as a defect may remain. The term groove will be used generally to describe all surface indentations, and mechanically-induced defect structures extending into the material.

A material may also be segmented into a plurality of segments. The boundary between two segments, if they remain proximate, is essentially a groove having a depth equal to the material thickness. The term groove will be used generally to describe such configurations.

In other examples, a wire grid, one or more blades, or grid of blades may be used. For example, an array of wires or blades may be used to produce an array of scintillator segments, which may then be retained together. The segments may be heated so as to at least partially stick together, or may partially fuse at the temperature at which the shaping element is urged against the material. However, this may not be a problem, as the interface can still provide a light guiding effect. Alternatively, a reflective coating may be first applied to the pieces, for example by dipping, evaporation, or other deposition process. Segments may be square, rectangular, triangular, or other geometric shape.

In other examples, the wires or blades may be heated, for example electrically heated, or using incident radiation. The material may remain at ambient temperature, or be heated to a softening temperature, or heated to close to a softening temperature, an additional energy input from the wire or blade providing the softening. In further examples, grooves may be formed before a hardening process is complete, for example before full curing, full polymerization or cross-linking, and the like. After groove formation, the material can be more fully hardened.

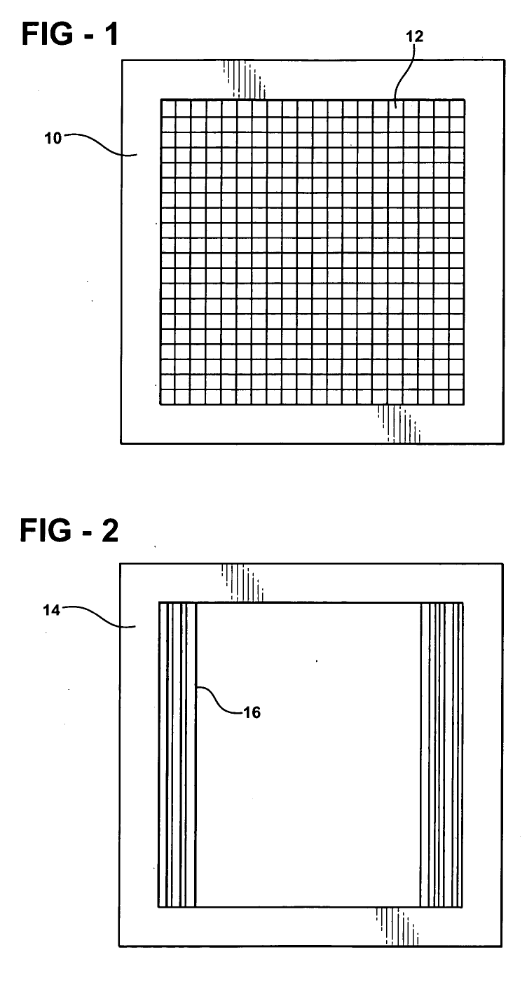

FIG. 1 illustrates a frame 10 supporting a wire grid 12. The wire grid is formed from orthogonal arrays of wires. The wires can be pressed into a material used for the scintillator or window, so as to form a grid of grooves. The wires can lie in the same plane, so as to produce a grooves having uniform depth. The wires can also be positioned so as to form deeper grooves proximate to the edges. The material can be softened before the groove formation, as discussed in more detail below.

FIG. 2 shows a frame 14, enclosing a frame aperture, a pair of wire arrays such as 16 being located within peripheral regions of the frame aperture.

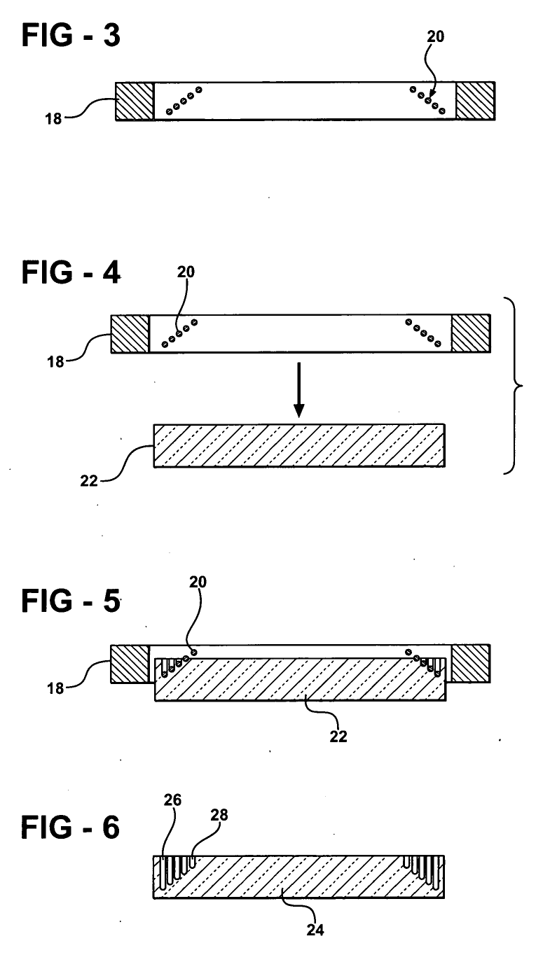

FIG. 3 is a side view of the frame 18 and wire grid 20. The wire array comprises wires positioned so as to form grooves of variable depth, in this case deeper grooves proximate to the edge of the frame. The inner edge of the frame shape may match the edge of the material to be cut.

FIG. 4 shows a side view of frame 18 and wire grid 20, the downward arrow showing a direction of movement of the frame towards the surface of a material 22. In an improved manufacturing process according to the present invention, the frame will be moved towards the surface, so that the grid or array of wires move in a uniform cooperative manner towards the surface.

FIG. 5 shows the situation after that illustrated in FIG. 4, in which the frame 18 has been moved so that the wire array 20 includes wires that have been pushed into the material. As the wires are pushed into the material they tend to form grooves in the surface. Using the configuration of wires as shown in FIG. 5, a pattern of grooves is formed in which the deepest grooves are closest to the outer edge of the material.

FIG. 6 shows an optical element formed using a method according to the present invention. Optical element 24 has an array of grooves, such as deep groove 26 close to the outer edge, and shallower groove 28 formed towards a central region of the material surface.

After formation of the grooves, the frame and wires can be removed. Alternatively the frame may be removed, and wires may be left in the material, for example trimmed at the edges of the material.

Shaping Elements

In certain examples discussed herein, the shaping elements are referred to as wires. However, this is for convenience only, and not limiting, as other elements can be used to form grooves within a surface. For example, blades or other elongate members can be used.

For example, the shaping elements can be metal wires having a high melting point, such as tungsten wires. The shaping elements may also include fibers, such as glass fibers, polymer fibers, or carbon fibers (including fullerene-type fibers). An electrically-conducting fiber may be electrically heated. In some examples, it may be advantageous to use an optical plastic as the fiber. In other examples, a main chain polymer (such as an aramid fiber) can be used. The polymer backbones may be aligned with the direction of the fiber so as to provide additional strength. In other examples, ceramic fibers can be used.

The shaping elements can be arranged in a rectangular or square grid, or alternatively may be provided as arrays of wires spaced at intervals along a certain direction. For example, multiple arrays of wires may be provided in a crossing pattern, so as to provide a hexagonal or other geometric grid. A pattern of crossing wires defines a plurality of apertures, square in the case of a square grid of wires, and which may also be triangular or other geometric shape in other arrangements. Wires may cross in the same plane, or a first array of wires may be in a plane spaced apart from an orthogonal array of wires.

Shaping elements may be curved, particularly where an optical element has a curved edge. For example, a shaping element may comprise concentric rings of blades.

Wires may be electrically heated, for example carrying an electric current so as to heat the wire above a softening or melting temperature of the material. The softening of the material may be local to the region around the wire, the wire softening a small zone of material as it passes through the material. Other effects of heated wires may include vaporization, other phase changes, and the like.

After depression of a wire array or grid into a material, the wires may be left in place. In one example, the frame is removed, and loose ends of the wires protruding from the sides of the material can be trimmed off. The wires may have no significant impact on the optical or other properties of the material, so that they may be left in place with little adverse effect.

However, in other examples the wires can be removed. For example wires may be burned away using an electric current, withdrawn from the material in a lateral direction, for example by removing one side of the frame and pulling the opposed side in a direction parallel to the surface of the material so as to extract the wires.

In some examples, an optical material such as an optical fiber may be left within the material, and this may have a beneficial influence on the optical properties of the material. In other examples, the shaping element may be a plate or blade, which is depressed into the surface of the material edge on. For example, a glass or crystal plate may remain in the material after being depressed therein, the plate then providing a light guide as discussed more fully in a co-pending patent application. The plates may be of a substantially different refractive index from the material to enhance the light guiding capability.

Shaping elements in the form of plates may be supported along one edge by a support plane, which provides the functionality of a frame. The support plane may be moved towards the surface, so as to press one or more plates into the surface of the material. For example, the plates may have different thicknesses or different widths, the widths being measured from the supported edge to the edge which first contacts the material surface, so that grooves of different depths and/or different thicknesses may be formed.

The edge of a shaping element in the form of a plate may be heated, for example by supporting a wire. Alternatively, the entire shaping element may be heated.

Groove formation methods described in this specification may be combined with conventional stamping processes, so as to provide a patterned surface topography in combination with one or more grooves. Further, when sawing either glass or plastic, it can be difficult to maintain a good reflecting surface at the site of sawn grooves. In some applications, such as scintillation crystals, it is advantageous to have good reflecting surfaces at the edges of grooves formed within a surface.

Wires or other shaping elements may have different diameters or thicknesses, so as to provide different groove widths. A heated fluid, gas jet, vacuum system, and the like may be used in conjunction with the groove formation process, so as to remove any debris, improve the smoothness of groove sides, and the like.

In other examples, the shaping element may be in the form of a tube, entering the material side-on. The center of the tube may carry a heated fluid, such as a heated gas, heated vapor, or heated liquid. The wall of the tube may be porous, so as to allow fluids out of the tube so as to improve the groove formation process. For example, water or some other solvent may exude from the porous walls of the tube so as to dissolve a soluble crystal. In other examples, a vacuum may be applied to the central region of the tube so as to tend to remove debris, vapors, fluids, or other materials produced by the groove formation process.

The shaping element may be provided by nanotubes, such as carbon nanotubes. Nanotubes may be single tubes, cables of a plurality of nanotubes, or nested nanotubes having a structure analogous to a stretched-out onion.

A shaping element may comprise a blade, wire, rod, or other elongate structure. The shaping element may comprise an element having a surface topography that is complementary to that desired in the optical element. For example, the shaping element may comprise a protrusion extending from a plate, such as a rod, fin, or the like, the plate acting as a supporting frame. In general, the surface topography of inorganic optical elements, such as halide crystals such as NaI, have not before been formed by urging a shaping element against the optical element. However, if the inorganic material has a high temperature plastic state, this can be used for shaping the surface. For example, grooves (including grating structures), periodic structures, light guiding components, microlenses, prisms, and other features can be produced in or on the surface of the optical element at low cost. A plate having apertures therein may be urged against a material so as to form protrusions from the surface of the material.

In other examples, the shaping element may be a porous material infused with a solid or liquid provided to improve the surface shaping process. A porous material may contain a lubricant, such as a wax, oil, molybdenum disulfide, or other material. Similarly, lubricants can be provided with other shaping elements, by spraying the surface of the material, providing a liquid flow, providing a layer on the surface to be shaped before the shaping process begins, or any other method. In other examples, the shaping element may comprise a porous material infused with an etchant such as an acid or the like.

Frame

The frame can be in the form of a rectangle, square, circle or ring, or other geometrical shape. The frame may be in the form of a tube, with shaping elements spanning the central opening. The frame may also have an open geometry, such as a V, C or U shape. The inside edge of the frame defines a frame aperture, and may also be in register with the outer edge of the optical element.

During groove formation, the frame is urged in a direction so as to press the shaping elements into the surface of the material. For example, the frame may lie in a plane substantially parallel to the surface of the material in which grooves are to be formed. In that case, if the wires are uniformly disposed within the frame, grooves of equal depth will tend to be formed. In other examples, the frame can be angled with respect to the material surface, so as to allow grooves of different depths to be formed, even if the shaping elements such as wires are not obliquely located within the frame.

An example frame may be rigid and generally flat, however in other examples variable groove depths may be provided using a frame having a pair of opposed curved portions. The shaping elements, such as wires, can be strung across between the two frame portions, so as to lie outside of a single flat plane. A square or other array of grooves may be provided by first depressing an array of shaping elements into the surface of the material, withdrawing the shaping elements, rotating the frame, and depressing the shaping elements again into the surface of the material. The rotation angle can be, for example, 90 degrees, so as to provide a square or rectangular grid. Optionally, the rotation angle may be 45 degrees, 60 degrees (so as to form a triangular or hexagon shape), or some other angular step.

During groove formation, the frame can be moved back and forth in a sawing motion, so as to facilitate the formation of grooves in a surface. The shaping elements may comprise conventional cutting materials such as diamond powder, even if the predominant mechanism for groove formation is the pressure of the shaping element on a softened surface.

A frame may further include an adjusting mechanism for adjusting the depth of a shaping element in relation to the frame. For example a substantially flat rectangular frame may provide for a uniform array of wires, so as to produce uniform depth grooves, and yet may after adjustment, provide a non-uniform array of shaping elements.

The frame may also include a stop element disposed across the frame opening. This may be a component functioning to prevent further urging of shaping elements into the surface, such as a flattened bar.

In other examples, the frame thickness may be chosen so that the frame comes to rest in contact with the surface supporting the material, at which point grooves of desired predetermined depths have been formed.

In other examples, shaping element position within the frame may be adjustable, for example by providing slots in the inner edge of the frame in which shaping element attachments can be moved.

Materials

The material may comprise glass, a plastic, an organic material, an inorganic material such as a crystal, or other material. The material may be a scintillation material, for example as described in more detail below.

One or more material preparation processes may be used before the groove formation process. For example, the material can be softened, for example by heating the material above a softening temperature. In the case of a glass, the material may be heated above the glass transition temperature. In the case of a plastic, the material may be heated until formation of grooves by pressure can be achieved without excessive force, where excessive force is a force that may tend to distort or break a shaping element.

A range of temperature may be chosen, in which the groove formation process works well, but the temperature is not so high that material degradation or groove degradation occurs.

In the case of polymers, a material may be partially polymerized, grooves formed within the material, then further polymerization and/or cross linking used to harden the material. In other examples, a plasticizer may be present within the material during the groove formation process, which is subsequently removed.

A number of processes may be applied to a material after the groove formation process is complete. For example the surface may be aluminized, or other reflective coating deposited, so as to provide a holographic grating. The surface may be doped, for example using activators, to provide a light emitting surface such as a scintillator, light emitting device array, and the like. The material may be mechanically deformed, so as to change groove dimensions. This is described in more detail below. Also, the material may be hardened after groove formation, so as to provide a robust element such as an optical element, for example a window or diffraction grating. The formed material may further be used as a mold for providing other shaped materials, such as a material having a complementary surface topography.

Grooves may be formed when the material is softer than it would be in a normal operating condition. For example the material can be heated, for example in a furnace, from below for example from a radiative plate, or by a radiation source of some kind. A subsequent hardening process may include curing (chemical, V, or other photo curing method).

The groove spacing may be changed after formation by the process described above, by deforming or otherwise modifying the material after the groove formation process. In one example grooves running along an X axis are provided in a slab-shaped material. The grooves are spaced a distance D along the orthogonal Y axis. Compressing or stretching along the Y axis will modify the groove spacing. Further, stretching along the X axis, for example using a drawing type process, may further modify the groove spacing, typically reducing the groove spacing. This approach may be used to form waveguides and photonic band gap reflectors.

The material may also be deformed so as to provide curved grooves, or grooves tending to extend in radial directions from a remote center. For example a plastic material may be curved into a desired shape.

A curved scintillator with grooves parallel to an edge may be formed using curved shaping elements, such as a curved blade. Alternatively, the grooves may be formed using straight shaping elements, and the scintillator curved after groove formation.

Previously, inorganic scintillator materials such as NaI have been shaped by sawing. However, this is very expensive, and the brittleness of inorganic crystals leads to low yields, for example due to chipping. However, NaI, other alkali halide crystals, and other inorganic crystals may show plastic behavior close to, but less than, the melting temperature of the crystal. For example, in U.S. Pat. No. 6,103,147 to Rybicki, curved crystals of NaI were fabricated using hot press forging in a plastic state, which for NaI exists between above approximately 300° C. and the melting temperature at 651° C. An example temperature range for press forging was given as between 520° C. and 570° C., and a similar temperature range can be used for shaping NaI crystals using methods according to the present invention. However, a higher temperature may be used, for example temperatures within 100° C. of the melting temperature, such as within 50° C. of the melting temperature. Higher temperatures tend to lead to faster fabrication, but may lead to smaller polycrystalline domain sizes and reduced mechanical strength.

Hence, inorganic scintillator crystals can be shaped according to embodiments of the present invention in the plastic state. A crystal may be press-forged first, for example as described in U.S. Pat. No. 6,103,147, to induce a polycrystalline form, and the polycrystalline form shaped according to embodiments of the present invention. In other examples, a polycrystalline form is prepared by fusion of a powdered material, which is then shaped according to embodiments of the present invention. Such a method of preparation can be far less expensive than conventional approaches.

The spatial resolution of a scintillator can be improved by the formation of grooves in the light emitting surface of the scintillator, or by segmenting a single crystal into a number of sub-divisions, for example in the form of a checkerboard or other geometric division (such as triangular segments). Conventionally, the formation of grooves in a crystal scintillator (such as NaI), or segmentation of a crystal, has been achieved by sawing the crystal. However, sawing is both difficult to perform without damaging the crystal, and consequently expensive due to the low yields. By heating a crystalline scintillator into a plastic state, grooves can be formed by pressing a shaping element into a surface. Similarly, a single crystal can be segmented in the plastic state by passing a shaping element through the crystal. Even if the segments tend to adhere (for example, by partial fusion) to each other after segmentation, light guiding properties of the boundary remain.

The yield for pressing grooves into the surface of a plastic state crystal is expected to be high compared with a conventional sawing approach. The shaping element used to form the grooves can be left in the crystal, and may help light-guiding.

Formation of grooves in a crystal scintillator in the plastic state allows a finer pitch of groove to be formed than is possible using sawing. Typically, sawn grooves are spaced apart every 1 cm. However, grooves formed according to embodiments of the present invention may have a spacing of 1-5 mm.

Scintillators may be formed by drawing process applied to a crystal in a plastic state, and this approach can be used to shape light guiding structures, such as light pipes, to direct scintillation to detectors.

Segmentation

By passing a shaping element, such as a wire, completely through a material, the material can be segmented into a plurality of elements. In effect, a groove is formed that passes through the thickness of the material. In some cases, the segments may remain adhered to each other after, for example, a wire is passed through them. However a reflecting surface may be provided by a resulting defect, grain boundary, or other non-uniformity formed by the process of passing the wire through the material. This may provide desirable light guiding properties.

Scintillation Materials

Scintillation crystals having improved positional accuracy can be provided by an example of the improved method described herein. Edge reflections can be reduced by providing grooves proximate to the edge, which may have variable depth. Positional accuracy is improved by reducing edge reflections using grooves, or by segmenting a scintillation crystal into a number of elements.

Methods described herein can be applied to form grooves on the surface of a scintillation material, to segment a scintillation material, or otherwise shape a scintillation material.

Scintillation materials may include halides (such as sodium iodide, cesium iodide), oxides (such as bismuth germanate (BGO), cadmium tungstate, gadolinium orthosilicate (GSO), cerium doped yttrium orthosilicate (YSO), cerium doped lutetium orthosilicate (LSO), and the like), other inorganic materials (for example, as inorganic crystals), organic crystals, other organic materials, and other materials. Scintillation materials may include an activator and a host material, in which the activator is dispersed or otherwise disposed. The activator may be a transition metal, such as a rare earth metal. Scintillation materials can be crystalline or non-crystalline. Non-crystalline scintillation materials may comprise, for example, polymers, glasses, and other materials providing light in response to incident radiation.

In examples discussed herein, the term “crystal” is sometimes used for convenience to refer to a scintillation material. However, examples discussed here apply equally to non-crystalline scintillators. Also, in examples discussed below, light guides are provided by grooves formed in one or more surface of the crystal (or associated window). As discussed in more detail below, other forms of light guide can also be used, for example, reflective films.

An improved method of producing an array of grooves in a surface of a scintillator comprises: heating or otherwise softening the scintillator (or other material in which grooves are to be formed), providing a plurality of wires, extending the wires across the surface of the scintillator, and forcing the wires against the surface so that the wires enter the material below surface, the wires being urged through the scintillator to a depth substantially equal to the desired groove depth. The wires may be left in, or removed.

The term “light guide” can be used to refer to any structures that may be provided within a crystal to provide internal redirection of light. The light guide may be a groove (such as a groove formed in a surface of a crystal), and the term “groove” is used elsewhere for convenience to represent light guides. The term groove includes structures such as cuts, slots, and the like.

A light guide may include a groove, an interface between media of substantially different refractive indices, a reflective film, bubbles, defects, crystal defects such as crystal grain boundaries, fracture films, or other structure or components that provide redirection of light within the crystal before the light emerges from the light emitting surface. Light guides may also comprise embedded fibers, plastic films, or other materials.

A groove can be air filled, or filled with fill material such as a liquid, plastic, glass, reflective film (such as a metal film), multilayer reflective film, fibers, spheroids (for example, forming a photonic band-gap reflector), interferometric structure, inert gas, vacuum (if the scintillator is in a sealed housing), or other material.

A light guide can be substantially parallel to a proximate edge region, and/or substantially normal to a surface in which it is formed, or nearby surface. A plurality of spaced apart light guides can be formed within a peripheral region. The depth or other extent of each light guide can be inversely correlated with the distance of the light guide from the edge (the distance being measured between the light guide and the most proximate region of the edge).

In other examples, light guides can be provided across the full extent of a surface, not just in a peripheral region. As for peripheral light guides, the depth (or analogous extent) of the light guide can be inversely correlated with the distance from the nearest edge (less when further from the edge, the relationship can be linear or nonlinear).

A light guide can provide partial optical confinement of scintillation light between the light guide and either another light guide or an edge. The partial optical confinement can improve the positional accuracy of a radiation detector using the scintillator.

If the scintillator has an elongated form having a uniform cross-section, having a first end and a second end, light guides can be formed in peripheral regions proximate to one or both ends.

The number of light guides proximate to an edge may be a number within the range 1-20 (inclusive), such as in the range 1-10 (inclusive), for example, one, two, three, four, five, six, seven, eight, nine, or ten. Example scintillators were made with 5-7 grooves, which were found to improver positional accuracy near the edge.

Groove spacing may be regular (equal spacing), or non-equally spaced. Graduations in groove depth can be linear or non-linear with distance from the edge, or all grooves can be the same depth.

The positional accuracy of an imaging device can be increase by providing more closely spaced grooves. The groove spacing may be, for example, a fraction of a sensor diameter, such as a spacing within the range 0.01-1 times the sensor diameter, such as in the range 0.05-0.5 of the sensor diameter. The groove spacing may also be a fraction of the edge thickness, such as in the range 0.01-0.5 times the edge thickness.

If the grooves have variable groove depth, such as groove depths inversely correlated with distance from the edge, in some examples the shallowest groove may be approximately 1 mm, and the deepest groove approximately equal to half the edge thickness. In some examples, the grooves may be curved.

Methods and apparatus described herein can be used with any scintillation material, such as crystal or non-crystal scintillators, and also with other materials that produce light in response to non-ionizing radiation, such as fluorescent materials, or other optical elements in which edge reflections are a problem.

Applications of scintillation crystals include gamma ray cameras, and other radiation detectors and imaging devices, such as nuclear medical devices. Applications include positron emission tomography (PET), single photon emission computed tomography (SPECT), combined PET/SPECT, x-ray imaging, UV imaging, cosmic ray detection, and other imaging and detection applications.

The reduced attenuation using grooves in a peripheral region along, compared with provision of uniform grooves across an entire light emitting face, is advantageous for all applications, particularly where sensitivity is an issue (such as combined PET/SPECT devices).

Hence, an example improved radiation detector includes a scintillator, the scintillator having a light-emitting face, a radiation receiving face, and a periphery between the light-emitting face and the radiation receiving face, the periphery including an edge having an edge thickness. The scintillator emits scintillation light from the light emitting face in response to radiation incident on the radiation receiving face. The scintillator has a peripheral region proximate to the edge, the scintillator including one or more light guides formed only within the peripheral region. This is in contrast to other designs where light guides are formed uniformly across the surface of the scintillator. The peripheral region can be a region within approximately three times the edge thickness from the edge, or within a distance approximately equal to a sensor spacing or sensor diameter if an array of sensors is used, or within half a sensor diameter (or sensor spacing). The area of the peripheral region can be less than the area of a non-peripheral region (such as a central region) not proximate to the edge. The light guide provides an internal reflection or redirection of scintillation light within the scintillator, before the scintillation emerges from the light emitting face.

Hence, a scintillator, for use in a radiation imaging device, has a light-emitting face, a radiation receiving face, and a perimeter extending between the light-emitting face and the radiation receiving face, the perimeter including an edge, the edge having an edge thickness. The scintillator emits scintillation light from the light emitting face in response to radiation incident on the radiation receiving face. The scintillator includes one or more light guides, such as grooves. The light guides may be formed only within a peripheral region of the scintillator, proximate to an edge. Alternatively, light guides can be formed uniformly over the surface, or the scintillator material may be segmented, the interfaces between adjacent segments acting as light guides. The positional accuracy of a radiation imaging device can be improved by such light guides.

Windows for Scintillation Detectors and Other Applications

Methods described herein can be applied to form grooves on the surface of a window, to segment a window, or otherwise shape a window.

A scintillation detector typically comprises a scintillator (such as a crystal), a window bonded to the scintillator, and a plurality of light detectors. Positional accuracy of a scintillation detector may be enhanced by providing a plurality of grooves in the window.

If the radiation detector comprises a scintillator, a window, and an array of sensors, each sensor in optical communication with the light emitting face of the scintillator through the window, the light sensors having a light sensor diameter, the scintillator or the window can be provided with one or more grooves formed in one or both faces thereof, the one or more grooves being formed within a distance less than a light sensor diameter from an edge thereof.

A window generally comprises a material substantially transparent to relevant light wavelengths. Examples include glass, polymers (such as acrylic polymers, for example PMMA), transparent oxides, other inorganic materials, or other materials.

For example, a window may be bonded to, abutting, or proximate to the light output face of a scintillation crystal. The window can provide protection of the crystal from degradation, for example by protecting from scratches, moisture, fracture, and the like. The window may be formed from any material substantially transparent to the scintillation light.

The topography of the upper surface of a window may include triangular indentations, pyramids, truncated pyramids, cones of conic sections such as frustoconical shapes, lenses, microlens arrays, Fresnel lens patterns, or other surface features operable to guide light towards light sensitive regions of the sensor. Equivalently, a window may be slab shaped, with a separate layer in optical communication with the upper surface providing light guiding.

The window may have a thickness in the range 0.1-0.375 inches, though this is not limiting. If the window has a surface topography within the peripheral region, for example to direct light to sensors, grooves can be formed through such features. The grooves may be normal to the average plane of the upper surface, may be parallel to a proximate edge, or otherwise provided.

Light guides (such as grooves) can be provided in the window material, so as to reduce edge effects due to reflections from the edge of the window. The grooves in the window can be in addition to, or instead of, grooves in the scintillator.

Analogous geometries can be used to the crystal examples described previously, and vice versa. Grooves in the crystal can be combined with grooves in the window.

The window may overhang the crystal edges, which may reduce edge effects due to the crystal, and the addition of grooves in the window may further reduce edge effects due to reflections from the window edges.

Provision of grooves in the window can advantageously increase positional accuracy of an imaging device. The improvement may not be as great as grooves formed in a crystal. However, even if it is not possible to replace the crystal of an imaging device, the positional accuracy of the device can be improved by replacing a non-grooved window with a grooved window.

Optical Elements

The methods and apparatus described herein may be adapted to various applications, such as reducing edge effects in various optical elements including windows, lenses, fluorescent materials, light emitting devices and materials, waveguides (including light guiding materials such as light pipes), reflectors, prisms, fibers, lasers, and the like. The manufacturing methods described herein can be used to fabricate improved optical elements, for example by forming grooves in a peripheral region proximate to an edge from which edge effects arise.

Approaches described herein can be used generally to remove edge effects from optical elements. For example, a lens may be provided with one or more grooves around the periphery of one or both surfaces of the lens. Grooves (the term is used generally to refer to any light guide) may also be provided around the peripheral edges of corneal implants, spectacle lenses, and other lenses and/or lens arrays. For example, in a spectacle application, one or more grooves could be partially or completely covered by the frame.

Arrays of light emitting elements can be provided by providing a grid-shaped pattern of grooves within a surface. Individual columnar forms protruding from the surface may be doped, for example so as to provide emitted radiation of different wavelengths. This can provide a simple method of providing a light emitting display. Such a display could be addressed by direct, multiplexed electrical or optical means.

A lasing material may be provided with one or more grooves in the peripheral region of the light emitting face of the laser material. This may be used to reduce stray light emerging from the laser material.

A process according to the present invention is also advantageous in providing low cost diffraction gratings. These may be provided as surface gratings by groove formation. In addition, grooves may be backfilled with a second material, which may be opaque or a different refractive index for example, providing a diffraction grating due to the presence of a periodic array of elements. Photonic materials may also be formed using methods according to the present invention.

Grooves may also be provided in the peripheral regions of other optical elements and systems, such as along the peripheral region of waveguides, or other components of integrated optical systems. For example, they may reduce edge effects within a waveguide.

If groove spacing is provided on the order of the radiation wavelength a photonic band gap (PBG) effect or other interference effect may occur. Groove spacing may be controlled by the wire spacing, and also be the angle of the plane of a wire array to a material surface, or by mechanically deforming a material after groove formation, or other appropriate method.

The example methods described herein are suitable for large scale industrial processing. For example a conveyor belt may be used to position a material before a frame and shaping element combination as described herein. The shaping elements can then be depressed onto the surface of the material, the frame removed, and the material moved on for any further desired processing. As described above, shaping elements such as wires may remain in the material after groove formation, and stray ends may be removed by a chopping process.

Protection Layers

In further examples, a scintillator (or any other optical element) may comprise a material that can be unstable under certain ambient conditions. Sodium iodide, for example, is deliquescent. Conventionally, NaI scintillators are protected by an aluminum housing, which is epoxy sealed against a glass window transparent to the scintillation light. However, this conventional approach can be expensive, particularly with curved scintillators, and failure of the epoxy seal is not unknown.

A scintillator can be coated with a protection layer to mitigate the effects of ambient conditions. For example, the protection layer may protect against the effects of oxygen or moisture. The protection layer may comprise glass (applied by methods such as dip coating, sol-gel coating, spray-coating, or baking of a glass powder layer applied to the material), or a metal layer (such as a metal foil, sintered metal coating, or other metal layer, such as aluminum layers). These approaches are described in more detail below. For example, a protection layer can be formed on a scintillator by dipping the scintillator in molten glass, and polishing the glass at least on the light emitting surface. In another approach, powdered glass is applied to the surface of the scintillator, and baked to form a glass layer. The scintillator should have a high enough melting temperature to allow fusion of the glass powder into a protection layer. The scintillator may also be sprayed with glass, with surface tension helping form a uniform protection layer. The protection layer may also comprise a powdered metal sintered into a protection layer

The protection layer can be applied after formation of the grooves in the material, or other shaping of the material. Also, the protection layer may be only applied to a portion of the material surface, for example faces not used for light transmission.

A metal protection layer may be formed by dipping in molten metal, sintering of a powder, evaporation, thermal decomposition of a deposited metal compound, spraying, or other metal deposition technique. An additional metal film can be used to give mechanical strength. Scintillation light emerges from at least one face, for example one on which the metal protection layer is not formed, or removed. A combination of metal and glass protection layers can be formed, the scintillation light emerging through the glass. Powdered glass and metal may fuse together on heating to form a seal.

The protection layer may be surrounded by a metal or plastic sheet to add mechanical strength, for example as a 1/16″ thick aluminum band around the sides of the scintillator. Improved protection against moisture can be achieved using a glass protection layer such as described above, with a metal sheet used for mechanical strengthening. The metal sheet need not be used for protection against moisture as in conventional approaches.

The protection layer may provide the function of a window for a scintillator, such as discussed above. The window may have grooves formed therein by a method according to the present invention. The window may also be applied to a scintillator having grooves, the window in part conforming to the grooved structure. The improved protection layers described above can be used with any optical element, including those not shaped according to embodiments of the present invention. For example, a glass protection layer can be advantageously applied to any scintillation crystal or other deliquescent optical element.

Other Examples

The improved method can be used for forming grooves in scintillation crystals, glass or plastic, for edge effect prevention and/or for improving resolution accuracy. This method has numerous advantages over the conventional sawing approach, such as lower risk of fracture (particularly for glass), no need for expensive diamond saws, and no need for pressure feedback on the shaping element (though this can be provided if required), and lower risk of burning or discoloring the material due to heat at the cutting point (particularly with plastic), and an improved reflecting surfaces at the sides of the grooves.

A grid of fine metal wires is constructed at the spacing and positioning desired for the grooves. The grid of wires could be a two-dimensional array, or a three dimensional array (which could resemble a screen or tennis racket string arrangement, on the scale desired). During manufacture, the scintillation material (such as a glass or plastic sheet) is heated to the point at which it is soft. The wire grid is then pressed into the soft material, causing the material to be partially extruded through the grid. The wire grid can be pressed only part way into the glass or plastic so as to produce grooves of a desired depth. The grid can be left in place as the material cools, although it could also be removed if required. The grid could also be passed the full way through the material to provide a simple method of producing a segmented scintillator. The method can be used with scintillation crystals (e.g. sodium iodide), glass (for example, the window) or plastic light pipe.

This manufacturing method also provides a much more cost-effective way of manufacturing devices having conventional configurations. For example, loops or rings of wire can be used to form columnar structures, or provide apertures in a material.

This method also provides an improved method of manufacturing photonic fibers, photonic band-gap materials, and other optical elements. After passing a wire array (such as a grid structure) through an optical material so as to form a pattern in the material, the material can then be stretched (for example, along the direction the wires passed, or along one or more axes) so as to form an elongated structure such as an optical fiber. The optical fiber would have the same pattern as the original wire array, but on a modified distance scale that can provide desired optical properties. The stretching can take place while the material is still warm, or the stretching can take place at a later time, optionally with additional heating. Optionally, stretchable fibers (metal, glass, or plastic) may be pushed into the softened material and not removed, the material then being stretched. As the shaping elements push through a material, the formed grooves may be back filled with a second material, such as a material having a different refractive index.

Embedded Structures

In examples of the present invention, structures are inserted into a material such as a scintillator, which subsequently remain embedded in the material. The material can be softened before insertion of the structures, for example by heating into a plastic state, or prepared as a soft material, for example as an uncured or partially cured polymer. After insertion of the structures, the optical material can be hardened, so that the inserted structures remain embedded within the material. The embedded structures may include reflecting, refracting, absorbing, or scattering structures. For example, reflecting films can be used to improve the spatial accuracy of a scintillator, or to modify the light-emitting or absorbing properties of an optical element. The embedded structures may also act as the shaping elements. Alternatively, insertion may follow the progress of a shaping element such as a wire through the material.

For example, structures can be at least partially embedded into the body of the material. The material may be softened before embedding, and then may be subsequently hardened. The embedded structures may be plates, films, disks, rods, rings, and the like. For example, a rectangular sheet or plate, having both width and length substantially greater than thickness, can be oriented edge-on to the surface of the material, and embedded by an urging process such as pressing. The edge may be sharpened to assist embedding, and the sheet may have the form of a blade. A plurality of such sheets can form light guides in an optical material, the light guides providing internal redirection of light. Embedded structures may act as light guides, which may include plastic, glass, or metal structures, such as sheets. For example, a metal sheet (or foil) may present a reflective surface when embedded within the material, for example as for an improved scintillator.

Embedded structures such as described above may be selectively removed after embedding so as to provide grooves or other air-filled gaps. Selective removal may include heating (for example, burning or vaporization), dissolution, laser ablation, microbe consumption, mechanical abrasion, or other process.

Embedded structures may include radio-opaque structures, which effectively localize the radiation within the scintillator and improve the spatial resolution of scintillators used to detect the radiation. The embedded structures may effectively collimate radiation within a scintillator, and also act as a light-guide to guide scintillation out of the scintillator.

A shaping element may be radio-opaque, for example comprising lead, tantalum, or tungsten. A radio-opaque structure, which may also be termed a shielding element, can be introduced into the scintillator to reduce the “depth of interaction” problem.

For example, in positron emission tomography (PET) imaging, the scintillator may be thick compared to x-ray imaging, for example having a thickness of 4-5 cm. Radiation such as a gamma ray on an oblique path through a scintillator (a path that is not at right angles to the radiation-receiving face) may progress through the light collection regions of several scintillation detectors. The detected location of the scintillation then depends on the depth the within the crystal at which the scintillation is produced. However, the depth is generally not known, and this effect reduces the spatial resolution of the scintillator. This can be a serious problem, and one for which no satisfactory solution is described in the prior art.

Providing radio-opaque structures at intervals within the scintillator greatly reduces the depth of interaction problem by preventing gamma rays from taking oblique paths through the crystal. For example, shielding materials can be placed between scintillator segments, or within grooves formed in a scintillator. The crystal pieces may be formed using a shaping element, as described elsewhere, and furthermore the shaping element may then provide the shielding material, though this is optional. For example, a radio-opaque shaping element may remain embedded in the scintillator, and act as a shielding element.

Soft metals, such as lead, may be pressed into the surface of a scintillator in a plastic state. Even if the crystal is above the melting point of the metal, the pressure exerted by newly introduced material (such as initially solid metal) can be used to urge the molten metal further into the material so as to shape the material surface.

Methods according to examples of the present invention may also be used to form grooves in fibers, for example to shape the fiber end, or form fiber grating structures. A similar approach can be taken with optical waveguides.

Other Examples

A method of shaping a surface of a material comprises providing (one or more) shaping elements, shaping elements if plural being mechanically associated so as to move cooperatively, optionally softening the material, and forming grooves in the material by urging the shaping elements at least partway into the surface of the material. The shaping elements may be mechanically associated by a rigid frame, and the grooves being formed by applying pressure to the rigid frame. The shaping elements can be positioned within or on the frame so as to provide grooves of different depths in the material. The material can be optionally hardened after forming the grooves. The shaping elements may include a plurality of elongate members, such as parallel spaced apart wires or a wire grid.

A method of shaping a surface of a material may comprises providing a frame, the frame at least partially surrounding a frame opening, providing shaping elements such as wires disposed across the frame opening, and moving the frame so as to urge the wires at least partway into the material. Grooves of variable predetermined depths within the surface can be obtained. The material may be softened before groove formation, and hardened afterwards. A portion of each wire may remain embedded in the material after formation of the grooves. The wires and/or frame may be configured such that a first wire enters the material before a later wire, the first wire creating a deeper groove than the later wire. Wires can be positioned within the frame so that the grooves have predetermined depths and positions correlated with positions of the wires. The frame may be angled relative to the surface of the material.

Methods according to the present invention allow shaping a surface of a scintillator (or other optical element) so as to increase positional accuracy of scintillation light emerging from the surface of the scintillator by depressing the shaping elements into the surface of the scintillator so as to form grooves in the surface of the scintillator, the grooves shaping the surface of the scintillator so as to increase positional accuracy of the scintillation light. The shaping elements can be configured so as to form the grooves in a peripheral region of the surface of the scintillator proximate to an edge of the scintillator, the scintillator having a central region less proximate to the edge having no grooves formed therein. The peripheral region may have an area less than the central region. The shaping elements can also be configured so that each groove has a depth correlated with a distance of the groove from an edge of the scintillator.

An apparatus for forming grooves in a surface of a material comprises a frame at least partially surrounding a frame opening, the frame having a frame thickness, the frame opening having a depth substantially equal to the frame thickness; and shaping elements extending across at least a portion of the frame opening. Each shaping element has a depth within the frame opening measured in a direction parallel to the frame thickness, and the shaping elements can be positioned to provide grooves of different depths within the material. An example frame opening has a substantially rectangular shape, the shaping elements connecting opposed first and second members, the first end second members being rigidly interconnected by a third member. The shaping elements can be grouped into first and second groups, the frame aperture having a central region between the first and second groups having no shaping elements, with the central region being a majority portion of the frame aperture. The apparatus can be used to form grooves having a depth distribution tending towards deeper grooves near the edge of the material.

An example apparatus to shape an inorganic crystal such as sodium iodide further comprises a heater, to heat the inorganic crystal into a plastic state, a shaping element, and a mechanical press, to urge the shaping element against the inorganic crystal when it is in the plastic state.

The invention is not restricted to the illustrative examples described above. Examples are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the claims. Subheadings in the specification are provided for convenience only. Examples, alternatives, and the like should be sought within the entire specification.

Patents or publications mentioned in this specification are incorporated herein by reference to the same extent as if each individual publication was specifically and individually indicated to be incorporated by reference. In particular, U.S. Prov. Pat. App. Ser. No. 60/629,410, filed Nov. 19, 2004, and U.S. patent application Ser. No. 10/993,012, also filed Nov. 19, 2004, are incorporated herein by reference in their entirety. Additional information, for example regarding imaging systems, can be found in Applicant's issued U.S. Pat. Nos. 6,525,320, 6,525,321, and 6,504,157, and Pub. App. No. 2003/0136912, the entire content of all of which are incorporated herein by reference.

Having described my invention, I claim:

1. A method of shaping a surface of a material, the material being part of an optical element, the method comprising:
providing a shaping element; and
forming a groove in the surface of the material by urging the shaping element against the material, so as to shape the surface of the material.

2. The method of claim 1, wherein the optical element is a scintillator, and the surface is a light emitting face of the scintillator.

3. The method of claim 1, wherein the optical element is selected from a group of optical elements consisting of a lens, window, waveguide, reflector, laser, light emitting device, and fiber.

4. The method of claim 1 wherein the shaping element is supported by a rigid frame, the groove being formed by applying a force to the rigid frame.

5. The method of claim 1, further comprising softening the material before urging the shaping element against the material.

6. The method of claim 5, wherein the material comprises an inorganic crystal, wherein softening the material includes heating the inorganic crystal into a plastic state.

7. The method of claim 6, wherein the inorganic crystal is an alkali halide.

8. The method of claim 7, wherein the alkali halide is sodium iodide.

9. The method of claim 6, wherein the inorganic crystal is heated to within 100° C. of its melting temperature.

10. The method of claim 1, further comprising hardening the material after forming the groove in the material.

11. The method of claim 10, wherein at least part of the shaping element remains embedded in the material after hardening the material.

12. The method of claim 1, wherein the groove extends through the material so as to divide the material into segments.

13. The method of claim 1, further comprising providing a plurality of shaping elements mechanically associated so as to move cooperatively, the plurality of shaping elements forming a plurality of grooves in the material.

14. The method of claim 12, further including positioning the plurality of shaping elements relative to each other so as to form grooves of different depths in the material.

15. A method of shaping a surface of a material, the material being part of an optical element, the method comprising:
softening the material;
providing a shaping element; and
urging the shaping element against the material so as to form one or more grooves in the surface of the material, so as to shape the surface of the material.

16. The method of claim 15, wherein the optical element is selected from a group of optical elements consisting of a scintillator, a lens, a reflector, a window, a fiber, and a waveguide.

17. The method of claim 15, wherein softening the material includes heating the material.

18. The method of claim 17, wherein the material is an inorganic crystal, wherein softening the material includes heating the material into a plastic state.

19. The method of claim 15, further comprising leaving at least a portion of the shaping element embedded in the material, and further comprising hardening the material.

20. The method of claim 15, further comprising:
providing a frame, the frame at least partially surrounding a frame opening;
disposing shaping elements across the frame opening, the shaping elements being elongate;
moving the frame so as to urge the shaping elements at least partway into the material, so as to form one or more grooves in the surface of the material.

21. The method of claim 20, wherein the shaping element are generally parallel and spaced apart.

22. The method of claim 20, wherein the shaping elements are arranged in a grid.

23. A method of shaping a scintillator, the method comprising:
heating the scintillator into a plastic state;
placing a shaping element proximate to the scintillator; and
urging the shaping element against the scintillator so as to shape the scintillator.

24. The method of claim 23, wherein the scintillator comprises an alkali halide.

25. The method of claim 23, wherein the scintillator comprises sodium iodide.

26. The method of claim 23, further comprising cooling the scintillator, and leaving a portion of the shaping element embedded in the scintillator.

27. The method of claim 26, wherein the portion of the shaping element left embedded in the scintillator is radio-opaque.

28. The method of claim 23, wherein shaping the scintillator increases the positional accuracy of images formed using scintillator.
